(19) United States
(12) Patent Application Publication
(10) Pub. No.: US 2025/0128537 A1
(43) Pub. Date: Apr. 24, 2025

(54) HOLDER APPARATUS FOR A WRITING IMPLEMENT

(71) Applicant: Jeff Hohl, Lafayette, IN (US)

(72) Inventor: Jeff Hohl, Lafayette, IN (US)

(21) Appl. No.: 18/382,412

(22) Filed: Oct. 20, 2023

(51) Int. Cl. B43K 23/00

(52) U.S. Cl. CPC B43K 23/002; B43K 23/001; A45F 5/1566

(57) ABSTRACT

A holder apparatus for pen holder for mounting a pen or other writing implement to a wall includes a base, a receiver, and a stabilizer. The receiver is coupled to the base and defines a hole for receiving the writing implement. The stabilizer is spaced away from the receiver and has lateral portions which extend around the writing implement to retain the writing implement in alignment with a center axis of the hole of the receiver.

### BACKGROUND OF THE INVENTION

### (1) Field of the Invention

The disclosure relates to pen holders and more particularly pertains to a new pen holder for pen holder for mounting a pen or other writing implement to a wall.

### (2) Description of Related Art Including Information Disclosed Under 37 CFR 1.97 and 1.98

The prior art describes myriad pen holders but fails to describe a pen holder having an adhesive for mounting to a wall, a hole for receiving a writing implement, and a stabilizer spaced from the hole for retaining the writing implement in the hole.

### BRIEF SUMMARY OF THE INVENTION

An embodiment of the disclosure meets the needs presented above by generally comprising a base with a front surface, a rear surface, and a perimeter surface, the perimeter surface extending from the front surface to the rear surface. A receiver is coupled to and extends away from the front surface of the base. The receiver defines a hole which extends through a top side and a bottom side of the receiver. The hole also has a size such that the hole is configured to receive the writing implement. A stabilizer is coupled to and extends away from the front surface of the base and is spaced from the receiver. A recessed surface of the stabilizer faces away from the base and extends between a pair of lateral portions of the stabilizer. The pair of lateral portions is configured to prevent a movement of the writing implement away from the central axis of the hole.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a holder apparatus according to an embodiment of the disclosure.

FIG. 2 is a bottom rear side perspective view of an embodiment of the disclosure.

FIG. 3 is a side view of an embodiment of the disclosure.

FIG. 4 is a front view of an embodiment of the disclosure.

FIG. 5 is a cross section view of an embodiment of the disclosure taken from Arrows 5-5 in FIG. 4.

FIG. 6 is an in-use exploded view of an embodiment of the disclosure.

FIG. 7 is an in-use view of an embodiment of the disclosure.

FIG. 8 is a side view of an embodiment of the disclosure.

FIG. 9 is a top front side perspective view of an embodiment of the disclosure.

FIG. 10 is a top front side perspective view of an embodiment of the disclosure.

FIG. 11 is an in-use view of an embodiment of the disclosure.

### DETAILED DESCRIPTION OF THE INVENTION

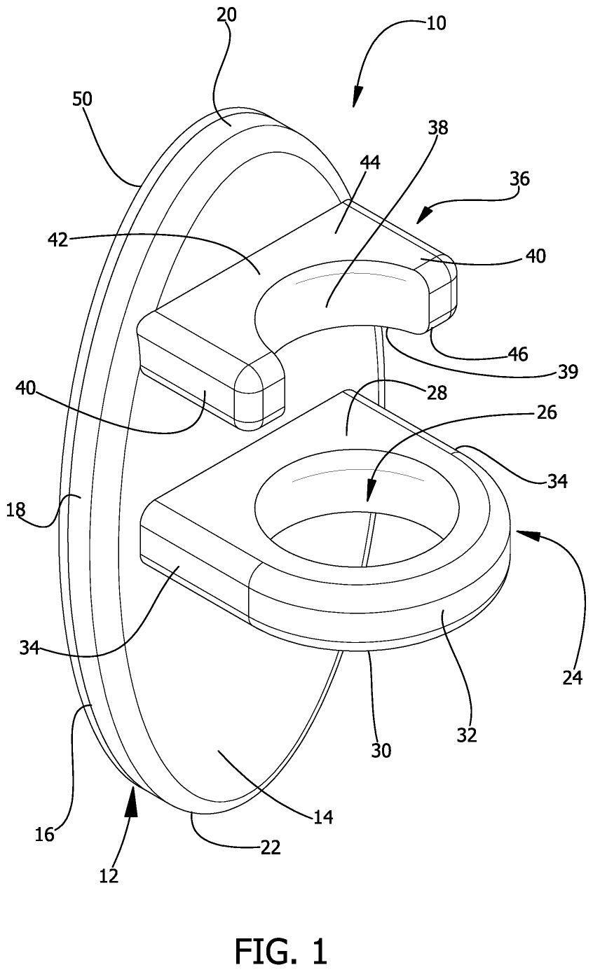

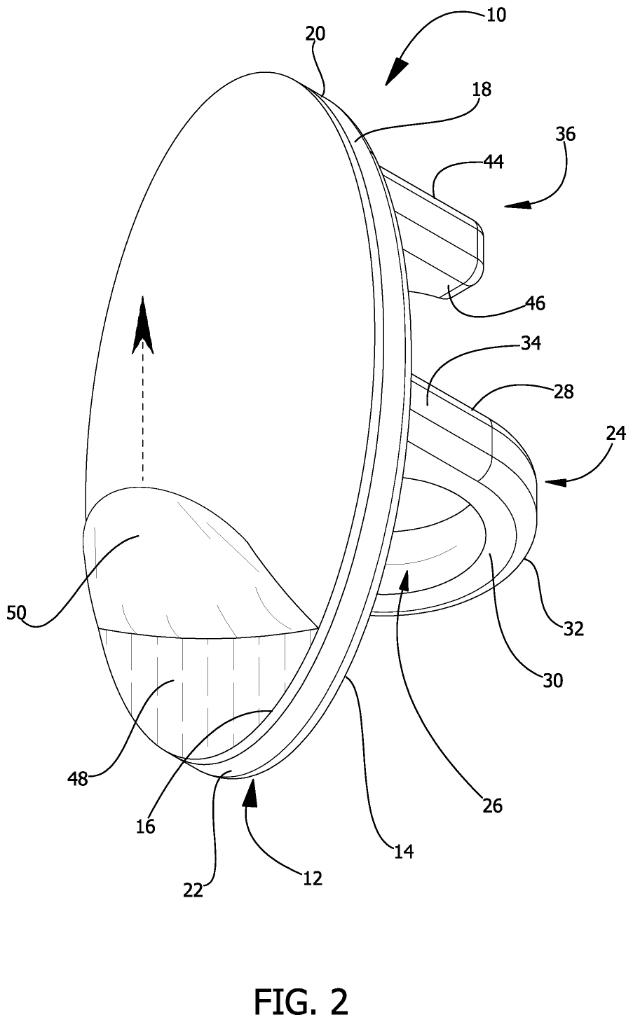

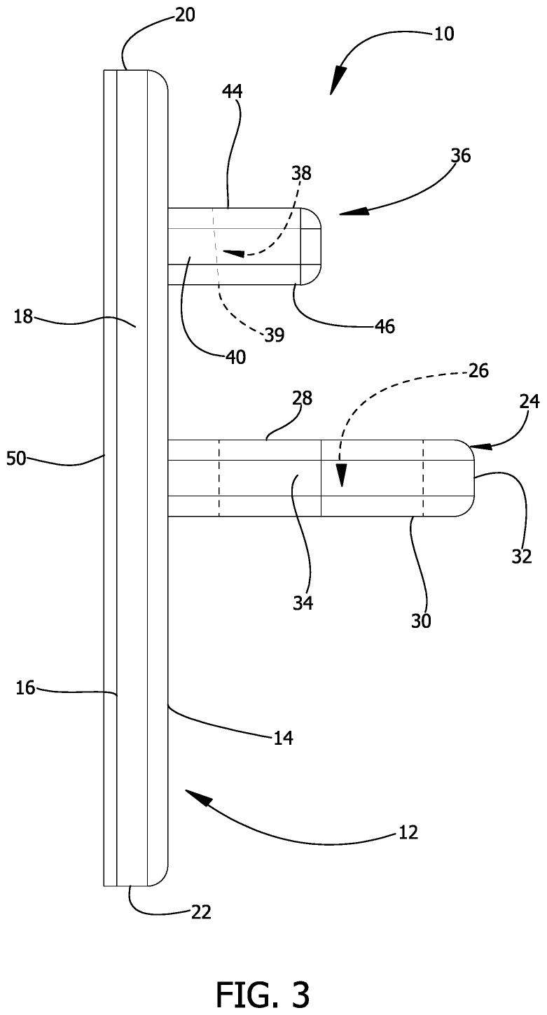

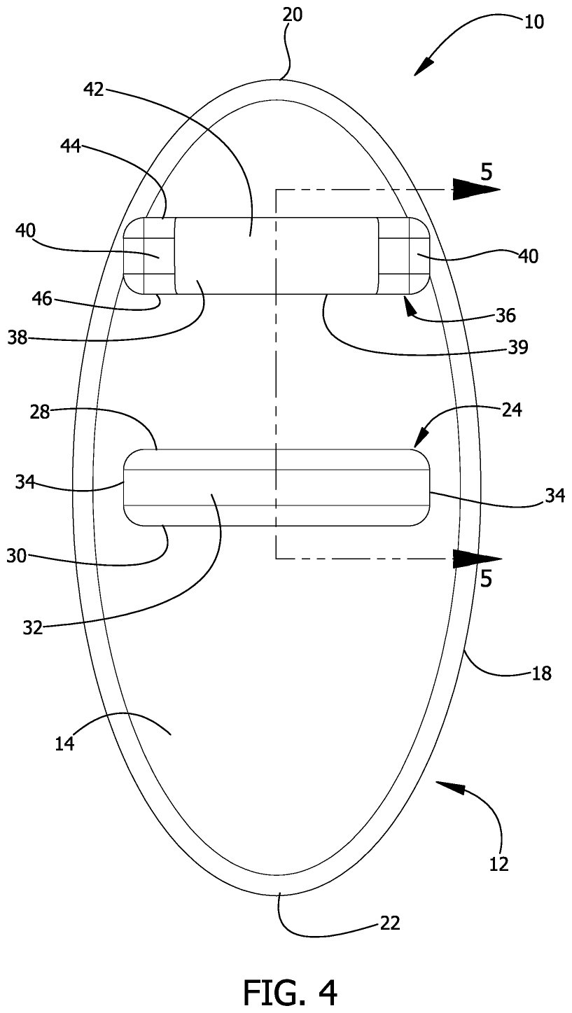

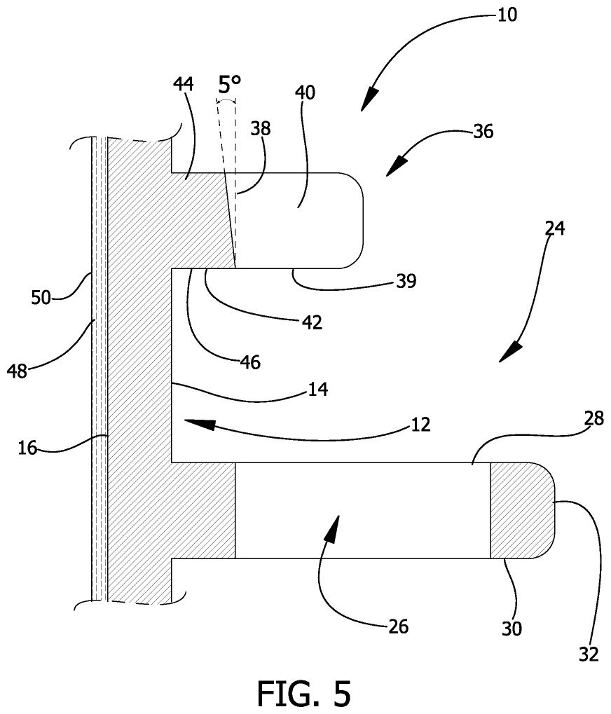

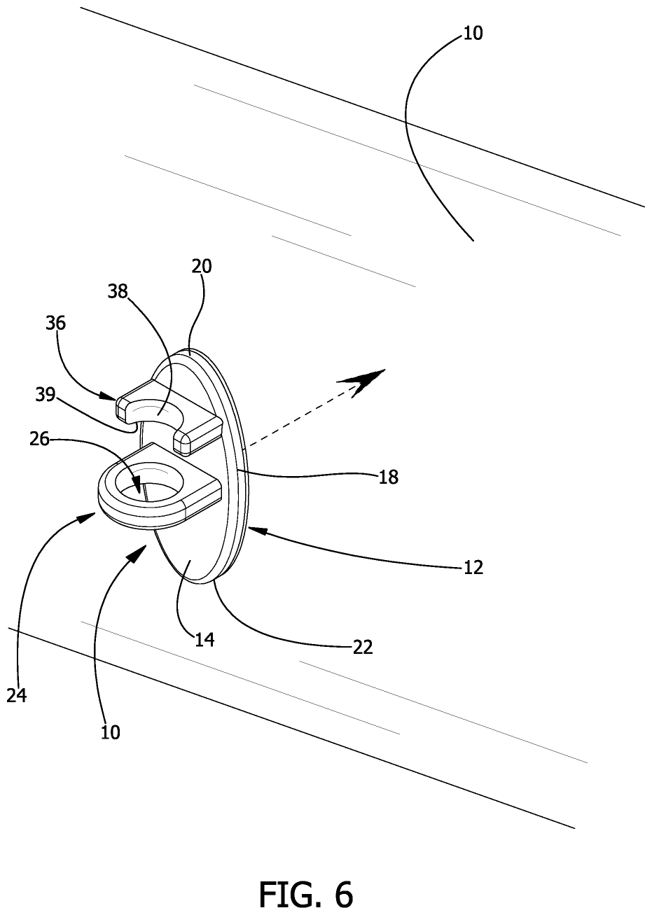

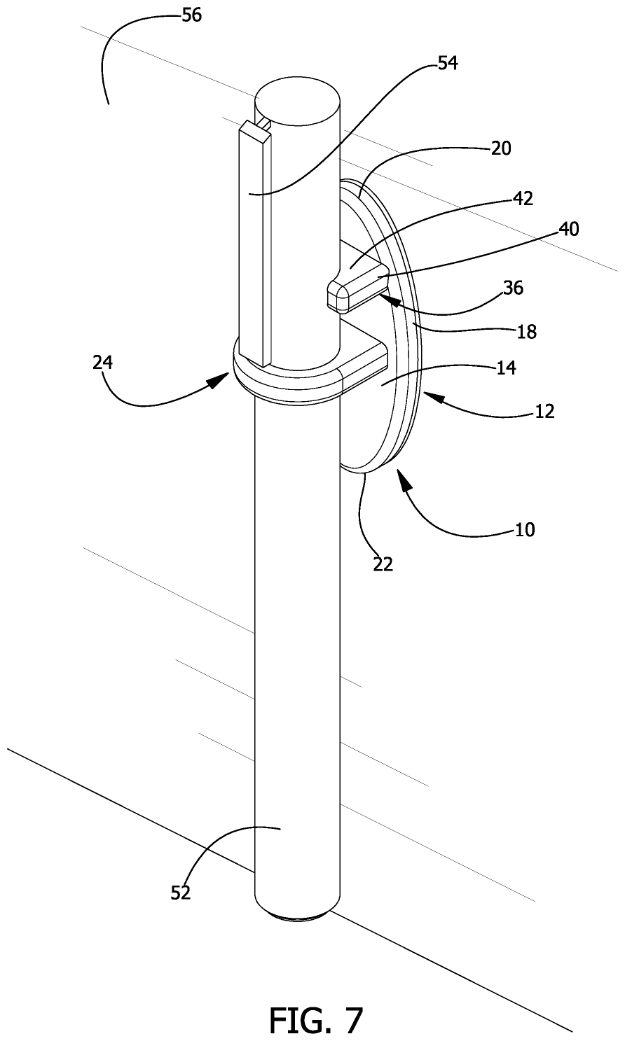

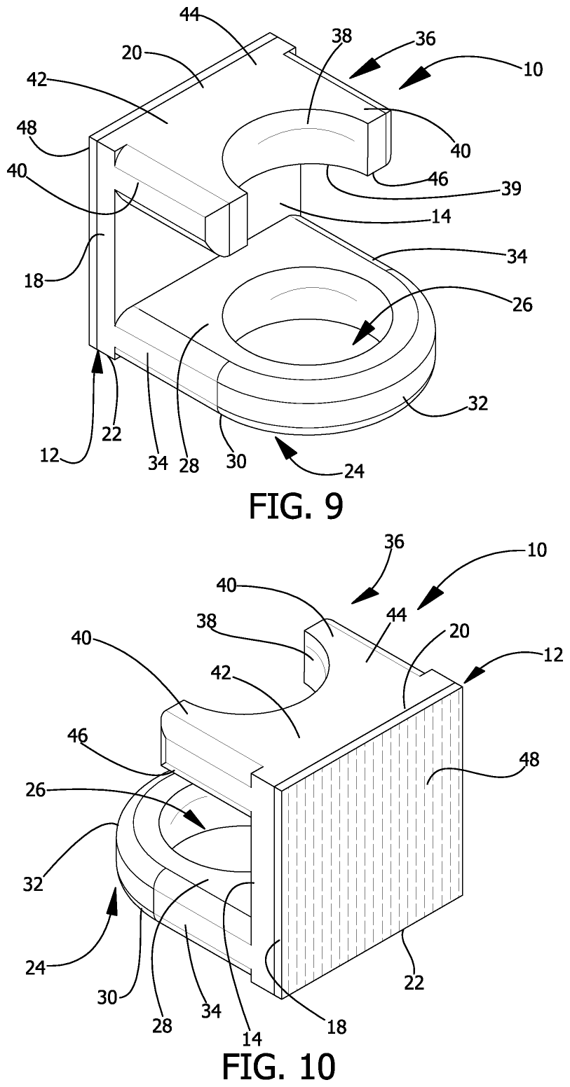

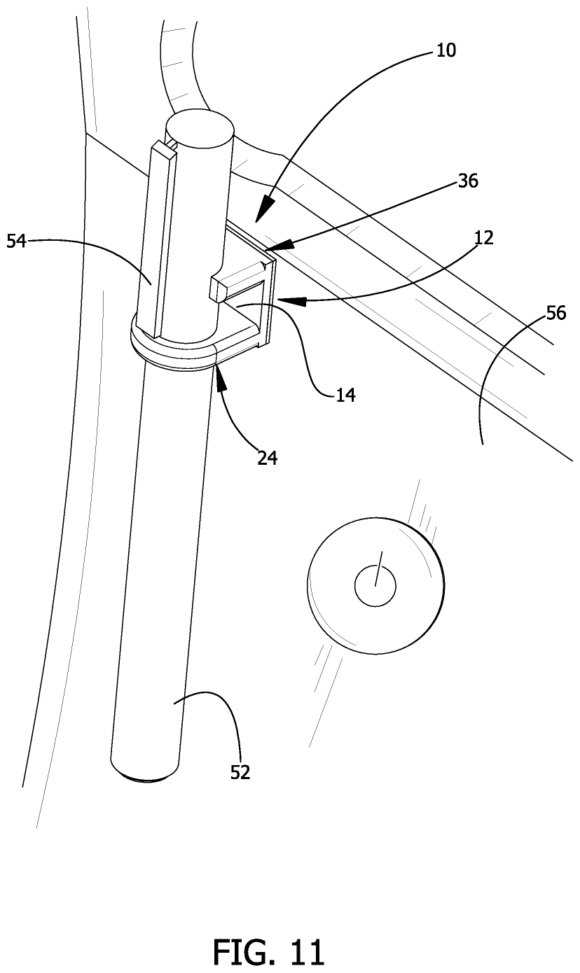

With reference now to the drawings, and in particular to FIGS. 1 through 11 thereof, a new pen holder embodying the principles and concepts of an embodiment of the disclosure and generally designated by the reference numeral 10 will be described.

As best illustrated in FIGS. 1 through 11, the holder apparatus 10 generally comprises a base 12 with a front surface 14, a rear surface 16, and a perimeter surface 18, the perimeter surface 18 extending from the front surface 14 to the rear surface 16. The rear surface 16 is planar, the front surface 14 is planar, and a thickness of the base 12 between the front surface 14 and the rear surface 16 is uniform.

A receiver 24 is coupled to and extends away from the front surface 14 of the base 12. The receiver 24 defines a hole 26 which extends through a top side 28 and a bottom side 30 of the receiver 24. The hole 26 has a size such that the hole 26 is configured to receive a writing implement 52, such as a pen, a wood pencil, a mechanical pencil, or the like. The top side 28 of the receiver 24 is configured to support a clip 54 of the writing implement 52, but the receiver 24 may also engage the writing implement 52 via friction. The top side 28 may also support other parts of the writing implement 52 such as an outwardly protruding wall, a ferrule, or the like.

A central axis of the hole 26 is oriented parallel to the front surface 14 of the base 12. The hole 26 has a circular cross section taken perpendicular to the central axis with a diameter that is uniform between the top side 28 and the bottom side 30 of the receiver 24. A front side 32 of the receiver 24 is convexly arcuate and extends between a pair of lateral sides 34 of the receiver 24. The front side 32 is positioned concentrically to the hole 26, and each lateral side 34 of the pair of lateral sides 34 is oriented perpendicularly to the front surface 14 of the base 12.

A stabilizer 36 is coupled to and extends away from the front surface 14 of the base 12. The stabilizer 36 is spaced from the receiver 24 and is positioned between the receiver 24 and a top end 20 of the base 12. In other embodiments, the stabilizer 36 may be positioned between the receiver 24 and a bottom end 22 of the base 12. A recessed surface 38 of the stabilizer 36 faces away from the base 12 and extends between a pair of lateral portions 40 of the stabilizer 36. The pair of lateral portions 40 is configured to prevent a movement of the writing implement 52 away from the central axis of the hole 26. A central portion 42 of the stabilizer 36 may also prevent the movement of the writing implement 52 away from the central axis of the hole 26.

The recessed surface 38 is concavely arcuate and is positioned concentrically to the hole 26 of the receiver 24. The recessed surface 38 tapers inwardly between an upper side 44 and a lower side 46 of the stabilizer 36. A tapering angle of the recessed surface 38 from the central axis of the hole 26 is between 4.0 degrees and 6.0 degrees.

An adhesive 48 is coupled to the back surface of the base 12 so that the base 12 may be adhered to a wall 56. A release liner 50 is removably coupled to the adhesive 48. In other embodiments, the base 12 may be attached to the wall 56 using threaded fasteners, clip 54s, or the like, or the base 12 may be integrally formed with the wall 56.

In one embodiment of the present invention, as depicted in FIGS. 1 through 7, the perimeter surface 18 of the base 12 has an elliptical shape, and a major axis of the perimeter surface 18 extends between the top end 20 and the bottom end 22 of the base 12. The receiver 24 is centered between the top end 20 and the bottom end 22 of the base 12, and the stabilizer 36 is spaced from the top end 20 of the base 12. The base 12 has a greater area and extends farther vertically than other embodiments, which enables the base 12 to adhere to the wall 56 better under a load applied to the holder apparatus 10.

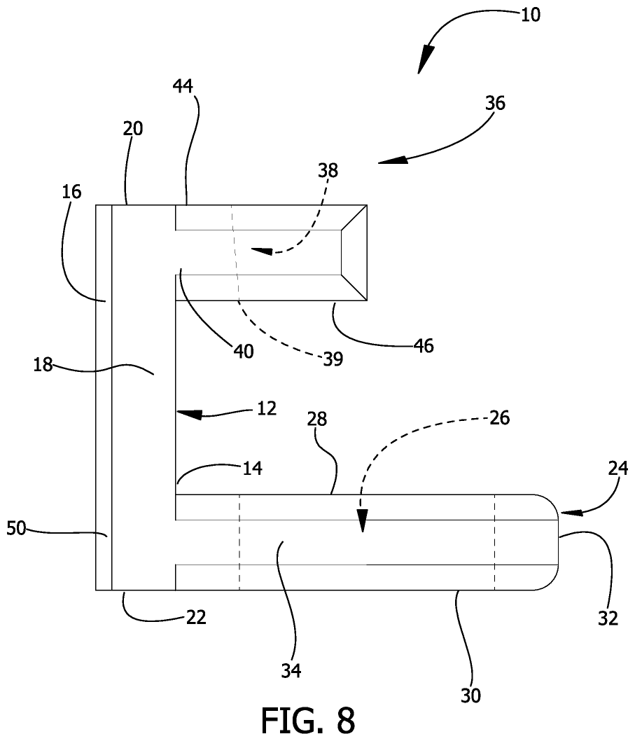

In reference to FIGS. 8 through 10, the perimeter surface 18 of another embodiment has a rectangular shape, the receiver 24 is positioned adjacent to the bottom end 22 of the base 12, and the stabilizer 36 is positioned adjacent to a top end 20 of the base 12. The base 12 of this embodiment has a smaller area than other embodiments, facilitating placement of the holder apparatus 10 in smaller spaces such as on a dashboard of a vehicle.

In use, the release liner 50 is removed from the adhesive 48 and the base 12 is bonded to the wall 56 via the adhesive 48. The writing implement 52 is inserted through the hole 26 of the receiver 24 and positioned against the recessed surface 38 of the stabilizer 36. The clip 54 of the writing implement 52 rests on the top side 28 of the receiver 24. The stabilizer 36 and the receiver 24 thereby cooperatively support the writing implement 52 in alignment with the center axis of the hole 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A holder apparatus for a writing implement, the apparatus comprising:
a base, the base having a front surface, a rear surface, and a perimeter surface, the perimeter surface extending from the front surface to the rear surface;
a receiver being coupled to and extending away from the front surface of the base, the receiver defining a hole which extends through a top side and a bottom side of the receiver such that said hole extends fully through said receiver, the hole having a size such that the hole is configured to receive the writing implement, a thickness of said receiver between said top side and said bottom side being less than a width of said receiver across said top side and said bottom side wherein said receiver is planar; and
a stabilizer being coupled to and extending away from the front surface of the base, the stabilizer being spaced from the receiver, a recessed surface of the stabilizer facing away from the base and extending between a pair of lateral portions of the stabilizer, the pair of lateral portions being configured to prevent a movement of the writing implement away from the central axis of the hole.

2. The apparatus of claim 1, wherein the rear surface is planar, the front surface being planar, a thickness of the base between the front surface and the rear surface being uniform.

3. The apparatus of claim 1, wherein the top side of the receiver is configured to support a clip of the writing implement.

4. The apparatus of claim 1, wherein a central axis of the hole is oriented parallel to the front surface of the base, the hole having a circular cross section taken perpendicular to the central axis.

5. The apparatus of claim 4, wherein a diameter of the hole is uniform between the top side and the bottom side of the receiver.

6. The apparatus of claim 4, wherein a front side of the receiver is convexly arcuate and extends between a pair of lateral sides of the receiver, the front side being positioned concentrically to the hole, each lateral side of the pair of lateral sides being oriented perpendicularly to the front surface of the base.

7. The apparatus of claim 4, wherein the recessed surface is concavely arcuate, the recessed surface being positioned concentrically to the hole of the receiver.

8. The apparatus of claim 1, wherein the recessed surface is concavely arcuate.

9. The apparatus of claim 8, wherein the recessed surface tapers inwardly between an upper side and a lower side of the stabilizer.

10. The apparatus of claim 9, wherein a tapering angle of the recessed surface from the central axis of the hole is between 4.0 degrees and 6.0 degrees.

11. The apparatus of claim 9, wherein a bottom edge of the recessed surface and the hole of the receiver have a same diameter.

12. The apparatus of claim 1, further comprising an adhesive being coupled to the back rear surface of the base.

13. The apparatus of claim 12, further comprising a release liner being removably coupled to the adhesive.

14. The apparatus of claim 1, wherein:
the perimeter surface of the base has an elliptical shape, a major axis of the perimeter surface extending between the top end and a bottom end of the base;
the receiver is centered between the top end and the bottom end of the base; and
the stabilizer is spaced from the top end of the base.

15. The apparatus of claim 1, wherein:
the perimeter surface of the base has a rectangular shape;
the receiver is positioned adjacent to a bottom end of the base; and
the stabilizer is positioned adjacent to a top end of the base.

16. A holder apparatus for a writing implement, the apparatus comprising:
a base, the base having a front surface, a rear surface, and a perimeter surface, the perimeter surface extending from the front surface to the rear surface, the rear surface being planar, the front surface being planar, a thickness of the base between the front surface and the rear surface being uniform;
a receiver being coupled to and extending away from the front surface of the base, the receiver defining a hole which extends through a top side and a bottom side of the receiver such that said hole extends fully through said receiver, the hole having a size such that the hole is configured to receive the writing implement, a thickness of said receiver between said top side and said bottom side being less than a width of said receiver across said top side and said bottom side wherein said receiver is planar, the top side of the receiver being configured to support a clip of the writing implement, a central axis of the hole being oriented parallel to the front surface of the base, the hole having a circular cross section taken perpendicular to the central axis, a diameter of the hole being uniform between the top side and the bottom side of the receiver, a front side of the receiver being convexly arcuate and extending between a pair of lateral sides of the receiver, the front side being positioned concentrically to the hole, each lateral side of the pair of lateral sides being oriented perpendicularly to the front surface of the base;
a stabilizer being coupled to and extending away from the front surface of the base, the stabilizer being spaced from the receiver, the stabilizer being positioned between the receiver and a top end of the base, a recessed surface of the stabilizer facing away from the base and extending between a pair of lateral portions of the stabilizer, the pair of lateral portions being configured to prevent a movement of the writing implement away from the central axis of the hole, the recessed surface being concavely arcuate, the recessed surface being positioned concentrically to the hole of the receiver, the recessed surface tapering inwardly between an upper side and a lower side of the stabilizer, a tapering angle of the recessed surface from the central axis of the hole being between 4.0 degrees and 6.0 degrees, a bottom edge of the recessed surface and the hole of the receiver having a same diameter;
an adhesive being coupled to the rear surface of the base; and
a release liner being removably coupled to the adhesive.

17. The apparatus of claim 16, wherein:
the perimeter surface of the base has an elliptical shape, a major axis of the perimeter surface extending between the top end and a bottom end of the base;
the receiver is centered between the top end and the bottom end of the base; and
the stabilizer is spaced from the top end of the base.

18. The apparatus of claim 16, wherein:
the perimeter surface of the base has a rectangular shape;
the receiver is positioned adjacent to a bottom end of the base; and
the stabilizer is positioned adjacent to a top end of the base.
